(19) United States
(12) Patent Application Publication
(10) Pub. No.: US 2026/0292343 A1
(43) Pub. Date: Sep. 24, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TAKUYA IWATA, Tokyo (JP)

(21) Appl. No.: 19/564,836

(22) Filed: Mar. 12, 2026

(30) Foreign Application Priority Data
Mar. 21, 2025 (JP) 2025-047270

(51) Int. Cl. H04N 23/695; H04N 23/69

(52) U.S. Cl. CPC H04N 23/695; H04N 23/69

(57) ABSTRACT

An information processing apparatus sets a first reference position for a plurality of subjects in a first captured image captured by an imaging apparatus, sets a first target position for the plurality of subjects in the first captured image, and controls the imaging apparatus so that the first reference position becomes the first target position.

### BACKGROUND

### Field of the Technology

The present disclosure relates to an information processing apparatus, an information processing method, and a storage medium.

### Description of the Related Art

There is an automatic tracking technology that detects a tracking target object, which is a subject determined as a target for tracking and shooting, from an image generated based on shooting by an imaging unit, and tracks and shoots the detected tracking target object. In the automatic tracking technology, in order to keep the detected tracking target object within a field of view of the imaging unit, an imaging direction and an imaging field of view of the imaging unit are controlled.

Japanese Patent Laid-Open No. 2016-12371 discloses a technology in which a subject is detected from a captured image, a scene is determined from information including a detection result, a composition for shooting the subject is determined based on the scene, and zoom control of an imaging apparatus is performed.

However, in Japanese Patent Laid-Open No. 2016-12371, since an end portion of the tracking target object is not considered, it has not always been possible to shoot a video of a composition desired by a user.

### SUMMARY

According to one embodiment of the present disclosure, an information processing apparatus is provided that, when tracking and shooting a plurality of tracking targets, brings positions of the tracking targets closer to an appropriate target height.

According to one embodiment of the present disclosure, an information processing apparatus sets a first reference position for a plurality of subjects in a first captured image captured by an imaging apparatus, sets a first target position for the plurality of subjects in the first captured images and controls the imaging apparatus so that the first reference position becomes the first target position.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of a configuration of an imaging system.

FIG. 2 is a block diagram illustrating an example of a hardware configuration of an imaging apparatus and an information processing apparatus.

FIG. 3A is a diagram illustrating an example of a functional configuration of the imaging apparatus.

FIG. 3B is a diagram illustrating an example of a functional configuration of the information processing apparatus.

FIGS. 4A, 4B, and 4C are diagrams for explaining a setting screen for a target position and a target size of a tracking target.

FIG. 5 is a sequence diagram illustrating an example of a process for setting a tracking target object.

FIG. 6 is a flowchart illustrating an example of a tracking process in the imaging apparatus.

FIGS. 7A and 7B are diagrams for explaining a process in a case where there is a single tracking target object.

FIGS. 8A, 8B, 8C, and 8D are diagrams for explaining a process in a case where there are a plurality of tracking target objects.

FIG. 9 is a diagram for explaining variations of zoom control.

FIGS. 10A and 10B are diagrams for explaining an example of a tracking process according to Embodiment 2.

FIGS. 11A and 11B are diagrams for explaining an example of a tracking process according to Embodiment 3.

FIGS. 12A and 12B are diagrams for explaining a different example of the tracking process according to Embodiment 3.

FIGS. 13A and 13B are diagrams for explaining a different example of the tracking process according to the Embodiment 3.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Embodiment 1

### Configuration of Embodiment 1

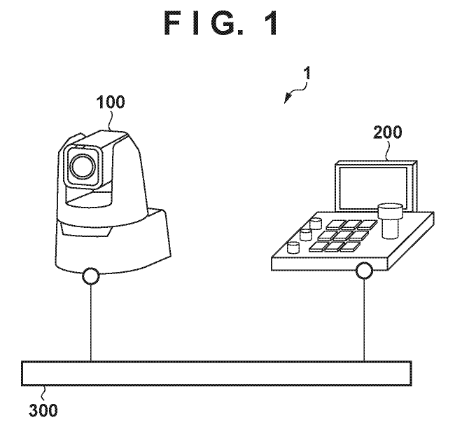

FIG. 1 is a diagram illustrating an example of an overall configuration of an imaging system 1 including an information processing apparatus 200 according to the present embodiment. The imaging system 1 according to the present embodiment is a system that detects one or more subjects to be tracking targets from a captured image by an imaging apparatus 100, and performs shooting while performing tracking processing for tracking the detected subjects. Here, a subject determined in advance as a tracking target may be referred to as a "tracking target object". In the present embodiment, a human is used as the tracking target object, but any object such as a vehicle or an animal like a dog can be used as the tracking target object as long as it is a subject detectable in a captured image. In the following, an image generated by the imaging apparatus 100 may be simply referred to as a captured image.

The imaging system 1 includes the imaging apparatus 100 and the information processing apparatus 200. The imaging apparatus 100 and the information processing apparatus 200 are connected via a network 300.

The imaging apparatus 100 according to the present embodiment is, for example, a camera, and here shoots a captured image including a subject in a field of view. In the present embodiment, control of the imaging apparatus 100 is executed as tracking processing for one or more subjects in the captured image by the imaging apparatus 100. As the control of the imaging apparatus, for example, drive control such as pan, tilt, or zoom is performed. The zoom control by the imaging apparatus 100 includes zoom-in and zoom-out.

The information processing apparatus 200 controls the imaging apparatus 100. Although details will be described later, the information processing apparatus 200 according to the present embodiment sets one reference position for a plurality of subjects in the captured image by the imaging apparatus 100, sets a target position that is a target for the reference position, and controls the imaging apparatus 100 so that the reference position becomes the target position.

The information processing apparatus 200 is capable of displaying results of various processes and various types of information acquired from the imaging apparatus 100. Here, the information processing apparatus 200 displays the captured image acquired from the imaging apparatus 100 and detection results of subjects detected in the captured image, and can accept user input as to which of the detected subjects is to be a tracking target. In that case, the information processing apparatus 200 sets the subject selected by the user input as a tracking target object, and transmits information indicating the set tracking target object to the imaging apparatus 100. Also, the information processing apparatus 200 may acquire UI information for specifying imaging settings or tracking settings from the imaging apparatus 100, and accept selection by the user regarding settings of the imaging apparatus 100 by displaying the acquired information. Also, the information processing apparatus 200 transmits user setting information regarding settings of the imaging apparatus 100 to the imaging apparatus 100.

Here, the description is given assuming that the imaging apparatus 100 and the information processing apparatus 200 are separate apparatuses, but the configuration is not particularly limited to such a configuration as long as similar processing can be executed. The imaging apparatus 100 and the information processing apparatus 200 may be configured by a single computer, or may be realized by distributed processing by a plurality of computers. For example, the information processing apparatus 200 may be built into the imaging apparatus 100, and the imaging apparatus 100 may have some or all of the functions described as being performed by the information processing apparatus 200.

The network 300 is realized by, for example, a LAN (Local Area Network), a WAN (Wide Area Network) such as the Internet, or the like. In addition, the network 300 may be realized not only by the Internet but also by a telephone line, a dedicated digital line, ATM (Asynchronous Transfer Mode), a frame relay line, a cable television line, a radio line for data broadcasting, or the like, or a combination thereof.

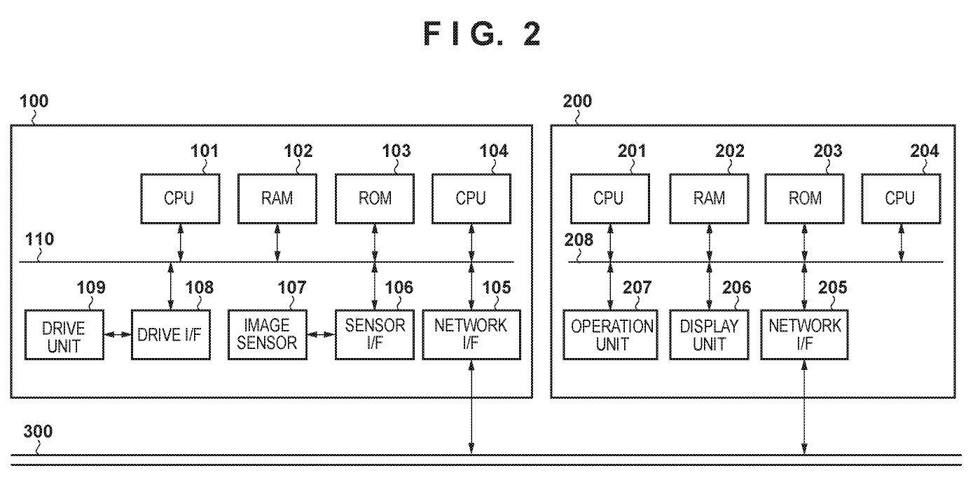

FIG. 2 is a block diagram illustrating an example of a hardware configuration of the imaging apparatus 100 and a hardware configuration of the information processing apparatus 200 according to the present embodiment. The imaging apparatus 100 includes a CPU 101, a RAM 102, a ROM 103, a GPU 104, a network I/F 105, a sensor I/F 106, an image sensor 107, a drive I/F 108, and a drive unit 109. Each functional unit of the imaging apparatus 100 is connected via a bus 110.

The CPU 101 controls the entire imaging apparatus 100 by executing various processes using computer programs or data stored in the RAM 102. The RAM 102 is a high-speed storage device such as a DRAM, and stores various types of information such as computer programs loaded from the ROM 103, captured images, or information acquired from the information processing apparatus 200. Also, the RAM 102 has a work area used when the CPU 101 or the GPU 104 executes various processes. The ROM 103 is a non-volatile storage device such as a flash memory, an HDD, an SSD, or an SD card, and stores setting data of the imaging apparatus 100, computer programs for starting up and basic operations of the imaging apparatus 100, data, and the like. Also, the ROM 103 stores computer programs or data for causing the CPU 101 or the GPU 104 to execute or control various processes described as processes performed by the imaging apparatus 100.

The GPU 104 performs inference processing for estimating the presence or absence of a subject, a region of a subject, or the like from a captured image. The GPU 104 is, for example, an arithmetic unit specialized for image processing and inference processing, such as a GPU (Graphics Processing Unit). Note that instead of the GPU 104, an arithmetic unit such as an FPGA (Field Programmable Gate Array) may be used. Also, the CPU 101 may handle the processing of the GPU 104. The network I/F 105 is an interface for connecting to the network 300, and communicates with an external device such as the information processing apparatus 200 via a communication medium such as Ethernet (registered trademark). The sensor I/F 106 converts a video signal output from the image sensor 107 into a captured image that is data of a predetermined format, and outputs the converted captured image to the RAM 102 after compressing it as necessary. Note that the sensor I/F 106 may perform various processes such as image quality adjustments like color correction, exposure correction, and sharpness correction, or crop processing for cutting out only a predetermined region, on the video represented by the video signal acquired from the image sensor 107. Also, these processes by the sensor I/F 106 may be implemented in accordance with instructions received from the information processing apparatus 200 via the network I/F 105.

The image sensor 107 receives light reflected from a subject, converts lightness and color of the received light into electric charge, and outputs a video signal based on a result of the conversion. As the image sensor 107, for example, a photodiode, a CCD (Charge Coupled Device) sensor, or a CMOS (Complementary Metal Oxide Semiconductor) sensor, or the like can be employed. The drive I/F 108 is an interface for transmitting and receiving instruction signals such as control signals to and from the drive unit 109. The drive unit 109 is a drive mechanism for changing an imaging direction of the imaging apparatus 100, and includes a mechanical drive system, a motor of a drive source, and the like. The drive unit 109 performs pan and tilt drive for horizontally and vertically changing the imaging direction, or zoom drive for optically changing an imaging field of view, in accordance with instructions received from the CPU 101 via the drive I/F 108.

The information processing apparatus 200 includes a CPU 201, a RAM 202, a ROM 203, a GPU 204, a network I/F 205, a display unit 206, and an operation unit 207. Each functional unit of the information processing apparatus 200 is connected via a bus 208.

The CPU 201 controls the entire information processing apparatus 200 by executing various processes using computer programs or data stored in the RAM 202. The RAM 202 is a high-speed storage device such as a DRAM. The RAM 202 stores computer programs and data loaded from the ROM 203, and various types of data acquired from the imaging apparatus 100. Also, the RAM 202 has a work area used when the CPU 201 or the GPU 204 executes various processes. The ROM 203 is a non-volatile storage device such as a flash memory, an HDD, an SSD, or an SD card, and stores setting data of the information processing apparatus 200, computer programs and data for starting up the information processing apparatus 200 and basic operations, and the like. Also, the ROM 203 stores computer programs or data for causing the CPU 201 or the GPU 204 to control various processes.

The GPU 204 performs inference processing for estimating the presence or absence of a subject, a region of a subject, or the like from a captured image. The GPU 204 is, for example, an arithmetic unit specialized for image processing or inference processing, such as a GPU. Note that instead of the GPU 204, an arithmetic unit such as an FPGA may be used. Also, the CPU 201 may handle the processing of the GPU 204. The network I/F 205 is an interface for connecting to the network 300, and communicates with an external device such as the imaging apparatus 100 via a communication medium such as Ethernet.

The display unit 206 has a screen such as a liquid crystal screen or a touch panel screen, and displays a captured image acquired from the imaging apparatus 100, a setting screen of the information processing apparatus 200, or the like. In the following, the description is given assuming that the display unit 206 has a touch panel screen. Note that in the imaging system 1, a display apparatus (not shown) different from the information processing apparatus 200 may be connected to the information processing apparatus 200 or the imaging apparatus 100, and the captured image and the setting screen of the information processing apparatus 200 may be displayed on the display apparatus. The operation unit 207 is a user interface that accepts an operation by a user on the information processing apparatus 200, and is, for example, a button, a dial, a joystick, a touch panel, or the like.

The information processing apparatus 200 may be a PC (Personal Computer) having a mouse, a keyboard, or the like as the operation unit 207, or may be a terminal device, and the configuration is not particularly limited as long as similar functions can be executed.

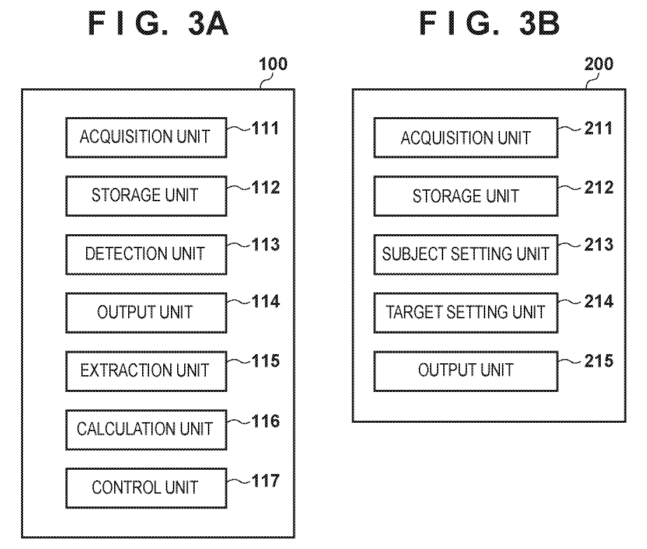

FIG. 3A is a block diagram illustrating an example of a functional configuration of the imaging apparatus 100. The imaging apparatus 100 according to the present embodiment includes an acquisition unit 111, a storage unit 112, a detection unit 113, an output unit 114, an extraction unit 115, a calculation unit 116, and a control unit 117.

The acquisition unit 111 acquires information from the information processing apparatus 200. The acquisition unit 111 can acquire, for example, information indicating a subject set as a tracking target object, imaging setting information of the imaging apparatus 100, or the like.

The storage unit 112 stores information acquired by the acquisition unit 111 or information generated by the imaging apparatus 100 such as a captured image.

The detection unit 113 detects a subject such as a person from a captured image, and detects a region of the subject in the captured image. The region of the subject in the captured image is, for example, a bounding box surrounding the subject, and is indicated by information indicating a size of the subject in the captured image, a length of the subject in the captured image, a position of the subject in the captured image, or the like. The subject detection processing by the detection unit 113 can be performed by any known technology for detecting a predetermined object in an image. The detection unit 113 according to the present embodiment performs inference processing using a learned model created using a machine learning method such as deep learning, thereby estimating a subject from an input captured image and outputting information indicating coordinates corresponding to a region of the subject as a result. Note that as the coordinates corresponding to the region of the subject, coordinates corresponding to a part or the entire region of the subject in the captured image are used. Also, as the coordinates corresponding to a part of the subject, coordinates corresponding to a contour of the subject, or coordinates corresponding to a head or a face of a subject that is a person, or the like are used. Also, as the coordinates corresponding to a part of the subject, in a case where the detection unit 113 detects the subject as a rectangle, coordinates of a top-left vertex and a bottom-right vertex of the rectangle, center coordinates of the rectangle, coordinates corresponding to a width direction of the rectangle, coordinates corresponding to a height direction of the rectangle, or the like are used. That is, the detection unit 113 has a function as subject detection unit configured to detect a specific subject from a captured image. In addition, the detection unit 113 also functions as position detection unit configured to detect a position of a tracking target object in a captured image. In addition, the detection unit 113 also functions as size detection unit configured to detect a size of a tracking target object in a captured image by the imaging apparatus 100.

As described above, the detection unit 113 according to the present embodiment is assumed to perform subject detection using a machine learning model, but is not particularly limited to this as long as the subject is detectable. For example, the detection unit 113 may use a template matching method in which a template image showing a subject to be detected and a captured image are compared, and a region in the captured image having a high similarity to the subject shown in the template image is detected as the region where the subject is shown.

In addition, the detection unit 113 identifies each of detected subjects based on features of the detected subjects, and generates information for identifying a subject for each identified subject. The detection unit 113 according to the present embodiment outputs information indicating a feature amount of a subject from an input captured image and a region of the subject in the captured image by performing inference processing using a learned model created using a machine learning method such as deep learning. The feature amount extracted by the detection unit 113 may be a feature amount of the entire subject, or may be a feature amount of a part of the subject such as a head or a face of a person. As the feature amount of the subject, for example, a feature vector of an image is used. In this case, it is sufficient to use a machine learning model in which captured images generated by shooting from various angles for each subject are used as learning images, images showing the same subject are labeled with the same ID and input to a learning model, and a feature vector is output.

In addition, the method for identifying a subject by the detection unit 113 is not limited to a method using machine learning. For example, the detection unit 113 may predict a region of a subject in the latest captured image from transitions of regions of subjects in past continuous captured images by a Kalman filter or the like, and identify a subject closest to the predicted region as the same subject.

The detection unit 113 generates information indicating coordinates corresponding to a region of a subject or information indicating a feature amount of a subject by detecting the subject, and causes the storage unit 112 to store the generated information. In the present embodiment, the information indicating coordinates corresponding to the region of the subject and the information indicating the feature amount of the subject generated by the detection unit 113 are treated as a result of detection by the detection unit 113 of the subject shown in the captured image.

The output unit 114 outputs information to the information processing apparatus 200. The output unit 114 outputs, for example, a captured image, information indicating a result of detection of a subject shown in the captured image by the detection unit 113, or UI information for specifying imaging settings or tracking settings, or the like.

The extraction unit 115 extracts a tracking target object in a captured image. The extraction unit 115 extracts the tracking target object from information transmitted from the information processing apparatus 200 as information indicating a subject set as a tracking target object and the result of detection by the detection unit 113 for the captured image. In a case where a plurality of subjects are set as tracking target objects, the extraction unit 115 extracts the plurality of tracking target objects in the captured image based on the result of the detection unit 113. Next, the extraction unit 115 generates information indicating which of the subjects detected by the detection unit 113 is a tracking target object, and causes the storage unit 112 to store it.

The calculation unit 116 calculates a position of the tracking target object extracted by the extraction unit 115 in the captured image and a size of the tracking target in the captured image. The calculation unit 116 according to the present embodiment calculates the position of the tracking target object using a center position of the tracking target object or an upper end position of the tracking target object. A detailed description of the upper end position of the tracking target object will be given later. In addition, the calculation unit 116 calculates a control amount for controlling (the drive unit 109 of) the imaging apparatus 100 based on the position and size of the tracking target. A method for calculating the control amount by the calculation unit 116 will be described in detail later.

In addition, in the present embodiment, since the upper end position of the subject is used as the tracking target object, in the following, a reference position may be referred to as an "upper end position", such as a "target position of the upper end position".

The control unit 117 controls operations such as pan, tilt, and zoom by the drive unit 109 of the imaging apparatus 100.

Each process by the acquisition unit 111, the detection unit 113, the output unit 114, the extraction unit 115, the calculation unit 116, and the control unit 117 of the imaging apparatus 100 is realized by the CPU 101 or the GPU 104 loading a program stored in the ROM 103 into the RAM 102 and executing it. In addition, the storage unit 112 of the imaging apparatus 100 is realized by the RAM 102 or the ROM 103.

FIG. 3B is a block diagram illustrating an example of a functional configuration of the information processing apparatus 200. The information processing apparatus 200 includes an acquisition unit 211, a storage unit 212, a subject setting unit 213, a target setting unit 214, and an output unit 215.

The acquisition unit 211 acquires information from the imaging apparatus 100. The acquisition unit 211 acquires, for example, a captured image, information indicating a result of detection by the detection unit 113 of the imaging apparatus 100 for the captured image, or UI information for specifying imaging settings or tracking settings. The storage unit 212 stores information acquired by the acquisition unit 211 and information generated by the information processing apparatus 200.

The subject setting unit 213 sets one reference position for a plurality of subjects in a captured image. Here, the subject setting unit 213 sets a subject to be a tracking target object among subjects detected by the detection unit 113, and sets one reference position for the set tracking target object. For that purpose, the subject setting unit 213 can cause the display unit 206 of the information processing apparatus 200 to display the captured image transmitted from the imaging apparatus 100 and information indicating the subjects detected by the detection unit 113 in the captured image, and accept user input. In that case, the subject setting unit 213 accepts selection of a tracking target object by a user based on the information displayed on the display unit 206, and sets the subject selected by the user as a tracking target object. In addition, the subject setting unit 213 generates information indicating which of the subjects detected by the detection unit 113 has been set as a tracking target object, and causes the storage unit 212 to store the generated information. In the following description, it is assumed that a plurality of subjects are selected as tracking target objects.

The subject setting unit 213 may set one reference position for the tracking target objects as, for example, the y-coordinate of the top of the head which is the uppermost (for example, the y-coordinate is the lowest) among subjects included in the tracking target objects. In the following, the "reference position" is described as information indicating a single position set using the coordinates of the top of the head of a subject included in the tracking target objects in this way. In addition, the coordinates on the image here are expressed in a coordinate system in which the origin is the upper-left end of the image, the positive y-axis direction extends downward, and the positive x-axis direction extends to the right. In addition, the x-coordinate of the reference position is assumed here to be the center of a region including all subjects included in the tracking target objects, but a detailed description will be given later.

The target setting unit 214 sets a target position (upper end target position) of the above-mentioned reference position in the captured image. Here, the target setting unit 214 sets a target position and a target value of a size of a tracking target in the captured image (hereinafter, also referred to as a target size). The target position and the target size can be determined by any method; for example, predetermined values may be used, or they may be determined based on user settings.

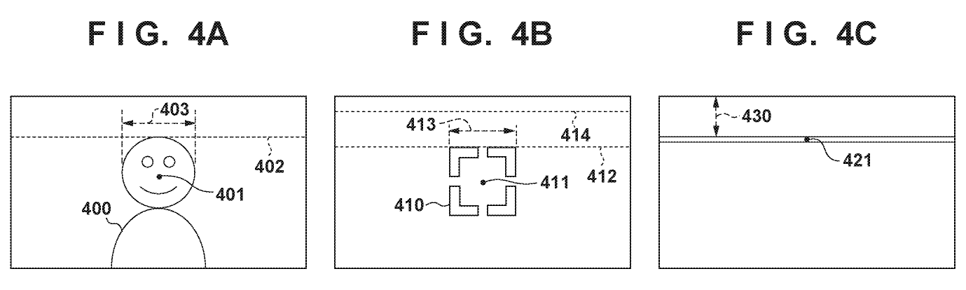

FIGS. 4A to 4C are examples of UI screens for determining a target position and a target size of a tracking target in a captured image. When a user sets a target, the target setting unit 214 uses UI information transmitted from the imaging apparatus 100 to display a UI screen for determining the target position and the target size of the tracking target in the captured image on the display unit 206.

FIG. 4A is a diagram illustrating an example of a UI screen for specifying a target position of a human head and a target size of the head using a position and a size of a humanoid silhouette image 400. In FIG. 4A, the user specifies the target position of the tracking target on the screen and the target size on the screen by operations such as moving the display position of the silhouette image 400 by a mouse operation or the like, or enlarging or reducing the size of the silhouette image 400 by a mouse operation or the like. In this example, the target setting unit 214 acquires a center target position 401 which is a target position of a center position of the head, an upper end target position 402 which is a target position of an upper end position of the head, and a target size 403 of a horizontal width of the head, based on the position and the size of the silhouette image 400 operated by the user. In addition, the target setting unit 214 causes the storage unit 212 to store the acquired target position and target size. Note that although the target size is set as the horizontal width of the head of the silhouette image 400 here, it may be in a different mode, such as setting a vertical width of the head or a diagonal width of the head as the target size.

Note that the UI for determining the target position and the target size is not limited to this. For example, instead of the silhouette image 400, a rectangular frame 410 as shown in FIG. 4B may be displayed to the user, and the user may specify the target position and the target size of the head using this. In this case, for example, the center of the rectangular frame 410 may be set as a center target position 411, the upper end of the rectangular frame 410 may be set as an upper end target position 412, and the width of the rectangular frame 410 may be set as a target size 413.

Note that the rectangular frame 410 shown in FIG. 4B may be a UI for specifying a target position and a target size of a face instead of the head. When the rectangular frame 410 represents a face, the upper end of the rectangular frame 410 is not the top of the head of the subject. In such a case, the subject setting unit 213 can set the upper end position by predictive calculation or the like using such a rectangular frame 410. For example, the subject setting unit 213 can set a point, which is above the upper end position of the rectangular frame 410 by a length 0.5 times the width of the rectangular frame 410, as the upper end target position 414, assuming that the distance from the upper end of the face to the upper end of the head is 0.5 times the face width.

In addition, as shown in FIG. 4C, the target position of the upper end position of the tracking target may be set by the user as a distance 430 (hereinafter, also referred to as headroom) to be secured between the upper end of the tracking target and the end of the captured image. For example, the subject setting unit 213 may allow the user to specify the target position of the upper end position of the tracking target by a horizontal straight line 421 as shown in FIG. 4C.

The output unit 215 outputs information to the imaging apparatus 100. Information output from the output unit 215 to the imaging apparatus 100 includes information generated by the subject setting unit 213 as information indicating the set tracking target object, information generated by the target setting unit 214 as the target position and the target size of the tracking target, and the like. In addition, the output unit 215 also performs output of images to be displayed on the display unit 206.

Each process by the acquisition unit 211, the subject setting unit 213, the target setting unit 214, and the output unit 215 of the information processing apparatus 200 is realized by the CPU 201 or the GPU 204 loading a program stored in the ROM 203 into the RAM 202 and executing it. In addition, the storage unit 212 of the information processing apparatus 200 is realized by the RAM 202 or the ROM 203.

### Operation of Embodiment 1

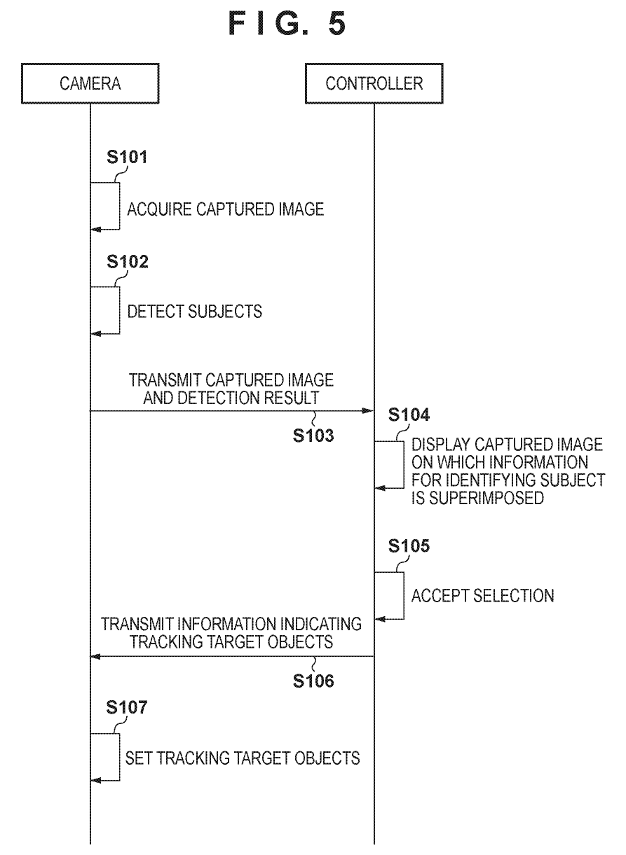

First, an operation of setting a tracking target object in the imaging system 1 will be described. FIG. 5 is a sequence diagram illustrating a flow from when the imaging apparatus 100 transmits a captured image to the information processing apparatus 200 until the tracking target object is set in the imaging apparatus 100.

In step S101, the acquisition unit 111 of the imaging apparatus 100 acquires a captured image generated by shooting. The captured image acquired by the acquisition unit 111 is stored in the storage unit 112.

In step S102, the detection unit 113 of the imaging apparatus 100 detects subjects from the captured image acquired in step S101, and detects regions of the subjects in the captured image. In addition, the detection unit 113 identifies the subjects by detecting features of the subjects and generates information for identifying the subjects. The detection unit 113 causes the storage unit 112 to store information indicating a detection result including the information for identifying the subjects.

In step S103, the output unit 114 of the imaging apparatus 100 transmits the captured image acquired in step S101 and the information indicating the detection result (information indicating the subjects) by the detection unit 113 generated in step S102 to the information processing apparatus 200.

In step S104, the output unit 215 of the information processing apparatus 200 causes the display unit 206 to display the captured image transmitted from the imaging apparatus 100 and the information for identifying the subjects. More specifically, the output unit 215 causes the display unit 206 to display the captured image on which the information for identifying the subjects is superimposed.

In step S105, the subject setting unit 213 of the information processing apparatus 200 accepts user input for setting subjects to be tracking target objects in the captured image displayed on the display unit 206. Note that the number of tracking target objects set here can be an arbitrary value, but it is assumed here that two or more subjects are selected as tracking target objects.

Here, the setting of the tracking target objects is not limited to being based on selection by a user, and for example, the subject setting unit 213 may set all subjects of a predetermined type (for example, humans) detected from the captured image as tracking target objects.

In addition, when one subject is selected as a tracking target object by the user, the subject setting unit 213 may set all subjects located in the vicinity of the selected subject (for example, an arbitrary range such as a circle with a radius of 100 pixels from a designated point) as tracking target objects. In addition, the subject setting unit 213 may set all subjects having features similar to one subject selected by the user on the captured image as tracking target objects. By doing so, the burden on the user for setting the tracking target objects is reduced compared to a case where selection by the user is required for all subjects to be set as tracking target objects.

Next, in step S106, the subject setting unit 213 of the information processing apparatus 200 transmits information indicating the tracking target objects among the subjects to the imaging apparatus 100 via the output unit 215.

In step S107, the extraction unit 115 of the imaging apparatus 100 sets tracking target objects in accordance with the information transmitted from the information processing apparatus 200 in step S106. Therefore, the extraction unit 115 also functions as setting means for setting a plurality of tracking target objects to be targets for tracking in shooting by the imaging apparatus 100. In addition, the extraction unit 115 causes the storage unit 112 to store information indicating the set tracking target objects.

Note that the processing shown in FIG. 5 may be performed every time the imaging apparatus 100 performs new shooting and generates a captured image. In that case, the setting of the tracking target objects may be updated in the imaging apparatus 100 and the information processing apparatus 200 every time a tracking target object is selected by the user.

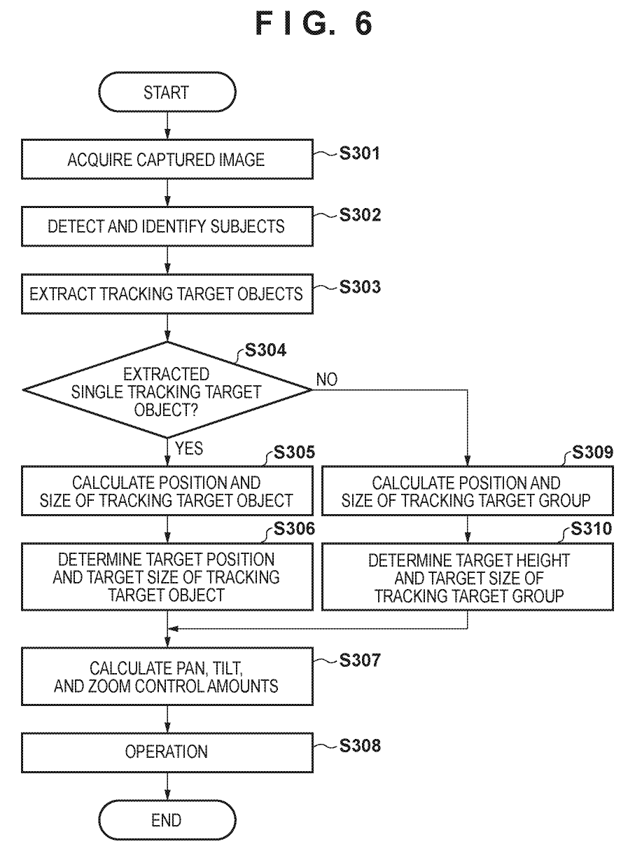

Next, an operation of tracking a subject that is a set tracking target object in the imaging system 1 will be described. FIG. 6 is a flowchart illustrating an example of tracking processing according to the present embodiment.

In step S301, the acquisition unit 111 acquires a captured image generated by shooting.

In step S302, the detection unit 113 detects subjects of the same type as the tracking target objects set in the extraction unit 115 from the captured image acquired by the acquisition unit 111, and identifies the subjects by detecting features of the respective subjects. For example, when the tracking target objects set by the extraction unit 115 are humans, the detection unit 113 detects humans as subjects that are candidates for the tracking target objects from the captured image.

Note that the processes in step S301 and step S302 may be the same processes as step S101 and step S102 shown in FIG. 5. If the processes in step S301 and step S302 and the processes in step S101 and step S102 are the same processes for the same captured image, the processes in step S301 and step S302 may be omitted.

In step S303, the extraction unit 115 extracts tracking target objects from the detected subjects. Here, the extraction unit 115 can extract the tracking target objects based on information received from the information processing apparatus 200.

In step S304, the extraction unit 115 determines whether or not a plurality of tracking target objects have been extracted in the captured image. If a plurality of tracking target objects have been extracted, the process proceeds to step S309, and if not, the process proceeds to step S305.

In step S305, the calculation unit 116 calculates a position (hereinafter, also referred to as a reference position) and a size (hereinafter, also referred to as a reference size) of the tracking target, and advances the process to step S306.

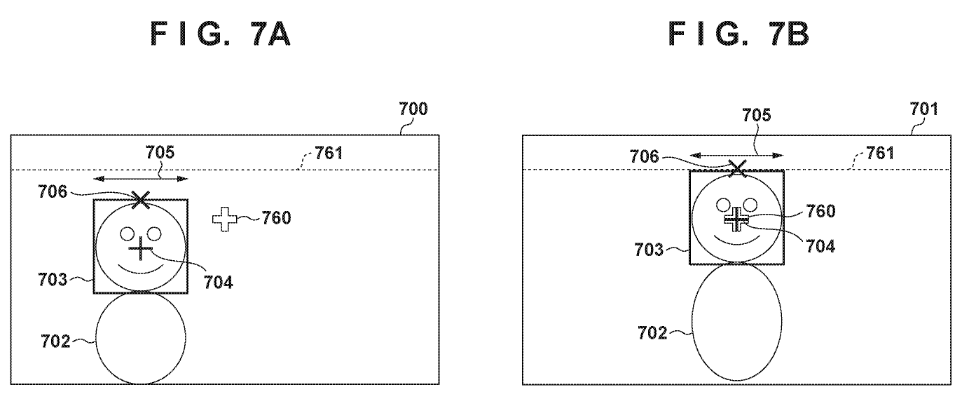

FIGS. 7A and 7B are diagrams for explaining a captured image and the reference position and the reference size of a tracking target calculated by the calculation unit 116 of the imaging apparatus 100.

A captured image 700 is shown in FIG. 7A. In addition, a tracking target object 702 is shown in the captured image 700. In addition, a target position 760, which is a target position regarding a center position of the tracking target, and an upper end target position 761 set by the user via the target setting unit 214, are shown. In addition, a rectangle 703 is shown in a region superimposed on the tracking target object 702. The rectangle 703 is a bounding box indicating the region of the tracking target object 702 detected by the detection unit 113. The calculation unit 116 calculates the reference position and the reference size of the tracking target from the captured image 700 shown in FIG. 7A, and causes the storage unit 112 to store information indicating the calculation results.

Note that the detection unit 113 according to the present embodiment is assumed to detect a head of a human as a subject to be tracked. That is, as in FIG. 7A, the rectangle 703 is superimposed near the head of the tracking target object 702. However, the superimposition of the rectangle 703 shown in FIGS. 7A to 7B is an example, and for example, the detection unit 113 may detect a human body and the rectangle 703 may be superimposed at a position surrounding the whole body of the tracking target object 702.

Note that in the imaging system 1 according to the present embodiment, when there is a single tracking target, the imaging apparatus 100 is controlled so as to bring the center position of the tracking target object closer to the center target position set by the target setting unit 214. Therefore, the calculation unit 116 calculates the center of the rectangle 703 of the tracking target object 702 as a reference position 704 of the tracking target. By performing processing to bring the center position of the tracking target object closer to the center target position, even in a case where there are individual differences in the shape of tracking target objects, it becomes possible to bring the subject position closer to a desired target position set by the user on average. Note that individual differences in the shape of tracking target objects include, when the tracking target object is a human head, differences in hairstyle, head size, face contour, or facial expression, or the like.

Note that in the imaging system 1 according to the present embodiment, the imaging apparatus 100 is controlled so as to bring the magnitude of the horizontal width of the tracking target object closer to the target size regarding the horizontal width set by the target setting unit 214. Therefore, the calculation unit 116 calculates the horizontal width of the rectangle 703 of the tracking target object 702 as a reference size 705 of the tracking target. Note that when the vertical width of the tracking target object is used as the target size of the tracking target, the calculation unit 116 may calculate the vertical width of the rectangle 703 as the reference size 705.

In step S306, the calculation unit 116 determines a target position, which is a target value of the position of the tracking target in the captured image, and a target size, which is a target value of the size, and advances the process to step S307. Here, the target position and the target size of the tracking target are assumed to be values set by the user via the target setting unit 214. Note that the target position 760 in the present embodiment is a target position regarding the center position of the tracking target object.

In step S307, the calculation unit 116 compares the reference position and the target position of the tracking target, and the reference size and the target size, respectively, and calculates control amounts for pan, tilt, and zoom (zoom magnification) in accordance with results of the comparisons. More specifically, the calculation unit 116 calculates control amounts for pan, tilt, and zoom for bringing the reference position 704 closer to the target position 760 and bringing the reference size 705 closer to the target size.

An example of specific calculation in step S307 will be described below. First, the calculation unit 116 determines a direction in which the reference position approaches the target position as a control direction for pan and tilt based on whether the reference position is positive or negative relative to the target position. In addition, the calculation unit 116 determines a direction in which the reference size approaches the target size as a control direction for zoom in accordance with a magnitude relationship of the reference size relative to the target size. Next, the calculation unit 116 determines pan and tilt speeds such that, for example, the speeds are faster as a deviation of the distance between the reference position and the target position is larger, and become zero when there is no distance deviation. In addition, the calculation unit 116 determines a zoom speed such that the speed is faster as a deviation between the reference size and the target size is larger, and becomes zero when there is no size deviation. By calculating the control speeds as described above, pan, tilt, and zoom operate until the deviation between the reference position and the target position and the deviation between the reference size and the target size are eliminated. Therefore, the reference position and the target position, and the reference size and the target size can be eventually matched.

Note that the method for determining the control speed of the imaging apparatus 100 is not limited to this. For example, for simplification of processing, the control speed may be determined to be a predetermined speed greater than zero when there is a difference between the reference position and the target position, and to be zero when there is no difference between the reference position and the target position.

In addition, instead of the case where there is no deviation between the reference position and the target position and no deviation between the reference size and the target size, the control speed may be set to zero when the deviation becomes less than a predetermined threshold (control is performed when the deviation is the threshold or more) (hereinafter, such processing is also described as dead zone processing). Accordingly, since pan, tilt, and zoom do not operate when the deviation between the reference position and the target position and the deviation between the reference size and the target size are minute, it is possible to stabilize the captured video without over-following minute movements of the tracking target object.

In step S308, the control unit 117 operates the drive unit 109 based on the details determined in step S307. More specifically, the control unit 117 gives an operation instruction indicating the details determined in step S307 to the drive unit 109. Accordingly, the drive unit 109 performs operations such as pan, tilt, or zoom in accordance with the instruction from the control unit 117. As a result, it becomes possible to bring the reference position of the tracking target closer to the target position and bring the reference size of the tracking target closer to the target size.

In this way, when step S301 to step S308 including step S305 to step S306 are repeatedly executed and the deviation between the reference position 704 and the target position 760 becomes zero, the captured image becomes like a captured image 701 shown in FIG. 7B. That is, the center position of the tracking target object matches the target position 760 specified by the user, and the display size of the tracking target object matches the target size (not shown) specified by the user.

Meanwhile, in step S309, which is a case where a plurality of tracking target objects are set, the calculation unit 116 calculates a reference position and a reference size of such a plurality of tracking target objects (here, referred to as a "tracking target group" to distinguish from a case where the tracking target object is a single subject), and advances the process to step S310.

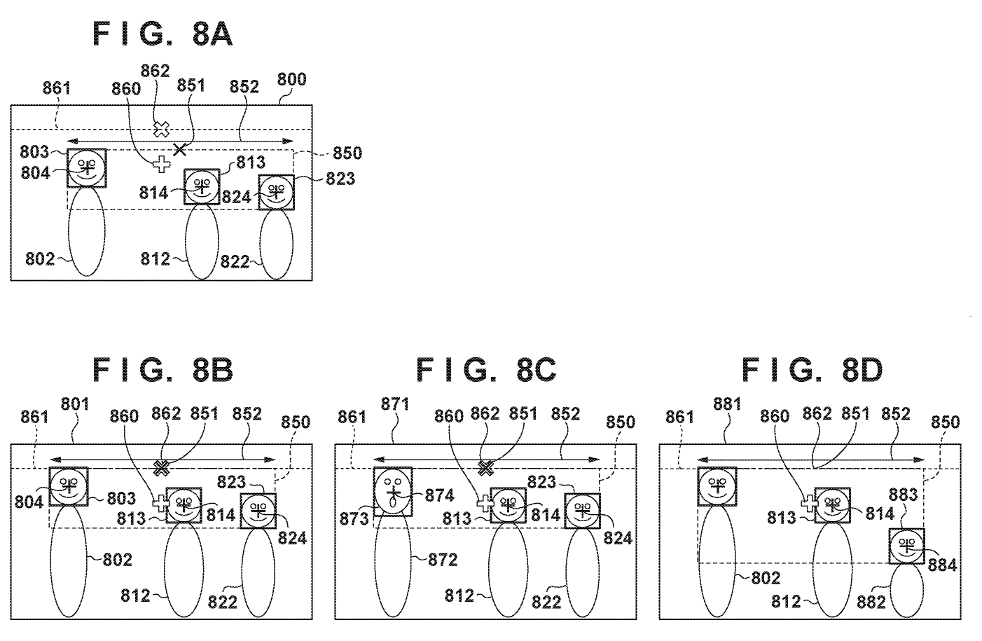

FIGS. 8A, and 8B, 8C, and 8D are diagrams for explaining a captured image and the reference position and the reference size of the tracking target group calculated by the calculation unit 116 of the imaging apparatus 100.

A captured image 800 is shown in FIG. 8A. In addition, a subject 802, a subject 812, and a subject 822 are shown as tracking target objects in the captured image 800. In addition, a rectangle 803 corresponding to the subject 802, a rectangle 813 corresponding to the subject 812, and a rectangle 823 corresponding to the subject 822 are shown in the captured image 800. Note that although each rectangle is displayed here assuming that the head of a human body is the tracking target, the superimposition position of these rectangles is not limited to this, and they may be superimposed at positions surrounding the whole body of the subjects.

The calculation unit 116 calculates a reference position 851 of the tracking target group from the captured image 800 shown in FIG. 8A.

In the present embodiment, among the subjects included in the tracking target group, the y-coordinate of the top of the head having the lowest y-coordinate on the image is set as an upper end position of the tracking target group, and the imaging apparatus 100 is controlled so that such an upper end position approaches the target position. Accordingly, regarding the subject with the narrowest headroom in the tracking target group, it becomes possible to perform control so that the headroom specified by the user is realized. In addition, regarding control in the horizontal direction, it is assumed that the imaging apparatus 100 is controlled so as to arrange the center position of the tracking target group (the center of a rectangular region encompassing all subjects to be tracking targets) at the center of the screen. Accordingly, it becomes possible to arrange the region where the tracking target group exists at a position such as one that is horizontally left-right equal relative to the screen. Note that the method for calculating the reference position of the tracking target group is not limited to this. Modified examples of the reference position of the tracking target group will be described in Embodiment 2 and Embodiment 3.

Through such processing, the calculation unit 116 calculates a rectangular region 850, which is a rectangular region encompassing the rectangle 803, the rectangle 813, and the rectangle 823, and calculates a reference position 851 on the calculated rectangular region 850. Here, the horizontal position of the reference position 851 is the center of the rectangular region 850, and the vertical position of the reference position 851 is the vertical upper end position of the rectangular region 850.

Note that in FIG. 8A, the vertical position of the reference position 851 was calculated assuming that the upper end position of the tracking target matches the upper end position of the rectangle, but the calculation processing is not limited to this. When the upper end of the subject region and the upper end of the rectangle do not match, the upper end position of the subject region may be acquired by acquiring the upper end position by predictive calculation or the like and calculating the rectangular region 850. For example, when a learned model capable of detecting a human face is used as the detection unit 113, the upper end position of the face can be detected, but the position of the top of the head, which is the upper end of the subject, cannot be directly detected. In such a case, for example, assuming that the distance from the upper end of the face to the upper end of the head is approximately 0.5 times the face width, a point above the upper end position of the rectangle by a length of 0.5 times the width of the rectangle may be set as the upper end position of the tracking target object.

In addition, the calculation unit 116 calculates a reference size of the tracking target group from the captured image 800 shown in FIG. 8A. When there are a plurality of subjects included in the tracking target objects, the imaging system 1 according to the present embodiment controls the zoom of the imaging apparatus 100 by controlling the field of view (zoom) in accordance with the spread of the tracking target group so that the size occupied by the tracking target group on the screen is kept constant. Here, the calculation unit 116 performs calculation processing so that the horizontal width of the rectangular region 850 becomes a reference size 852 of the tracking target group.

Note that the method for calculating the reference size of the tracking target group is not limited to this. For example, the vertical width or the diagonal width of the rectangular region 850 may be calculated as the reference size of the tracking target group. Alternatively, the larger of the ratio of the width length of the rectangular region 850 to the width length of the captured image 800 and the ratio of the height length of the rectangular region 850 to the height of the captured image 800 may be calculated as the reference size of the tracking target group. Alternatively, the calculation processing may be performed so that the area of the rectangular region 850 becomes the reference size of the tracking target group.

The calculation unit 116 causes the storage unit 112 to store information indicating the calculation result.

In step S310, the calculation unit 116 determines a target position, which is a target value of the position of the tracking target group in the captured image, and a target size, which is a target value of the size, and advances the process to step S307.

The target position and the target size of the tracking target group are determined based on the target values set by the user via the target setting unit 214. In the captured image 800 of FIG. 8A, a center target position 860 and an upper end target position 861 set by the user are shown. As described above, in the imaging system 1 according to the present embodiment, the y-coordinate of the top of the head having the lowest y-coordinate on the image is set as the upper end position of the tracking target group, and the imaging apparatus 100 is controlled so that such an upper end position approaches the target position. In addition, regarding control in the horizontal direction, the imaging apparatus 100 is controlled so as to arrange the center position of the tracking target group at the center of the screen. For that purpose, the calculation unit 116 calculates a group target position 862 shown in FIG. 8A as the target position. The horizontal position of the group target position 862 is the horizontal center position of the captured image 800. In addition, the vertical position of the group target position 862 is the vertical position of the upper end target position 861.

In addition, as described above, in the present embodiment, when there are a plurality of tracking target objects, the imaging system 1 controls the zoom of the imaging apparatus 100 by controlling the field of view (zoom) in accordance with the spread of the tracking target group so that the size occupied by the tracking target group on the screen is kept constant. For that purpose, the calculation unit 116 outputs the ratio to the screen width as the target size. For example, when the goal is to make the ratio occupied in the screen width 80%, the calculation unit 116 calculates a value of 80% of the screen width as the target size.

In the following, even when there are a plurality of subjects included in the tracking target object, each process is executed in step S307 to step S308 in the same manner as in the case where there is a single subject to be a tracking target.

In this way, when step S301 to step S310 including step S309 to step S310 are repeatedly executed and the deviation between the reference position 851 and the group target position 862 becomes zero, the captured image becomes like a captured image 801 shown in FIG. 8B. That is, it becomes possible to match the reference position 851 of the tracking target object group with the upper end target position 861 specified by the user. In addition, regarding the subject with the narrowest headroom in the tracking target group, it becomes possible to bring it closer to the width of the headroom specified by the user. In addition, it becomes possible to arrange the region where the tracking target group exists at a position such as one that is horizontally left-right equal relative to the screen.

FIG. 8C shows an example of a captured image different from FIG. 8B. In a captured image 871 shown in FIG. 8C, a subject 872 is shot instead of the subject 802 in FIGS. 8B, and in 8C, parts identical to those in FIG. 8B are denoted by the same reference numerals. Compared to the subject 802, the subject 872 has the same upper end position on the image and a different face shape. As described above, in the imaging system 1 according to the present embodiment, the y-coordinate of the top of the head having the lowest y-coordinate on the image is set as the upper end position of the tracking target group, and the imaging apparatus 100 is controlled so that such the upper end position approaches the target position. Therefore, even for the subject 872, it becomes possible to control the imaging apparatus 100 so that the upper end position approaches the upper end target position 861. In addition, since the upper end position of the tracking target group is used as the reference position, even if the subject 802 in FIG. 8B changes like the subject 872 in FIG. 8C, it becomes possible to make the headroom identical between the subject 802 and the subject 872.

Also, FIG. 8D shows a further example of a captured image different from FIG. 8B. In a captured image 881 shown in FIG. 8D, a subject 882 is shot instead of the subject 822 in FIG. 8B, and in FIG. 8D, parts identical to those in FIG. 8B are denoted by the same reference numerals. The subject 882 has a lower upper end position on the image compared to the subject 822. On the other hand, in FIG. 8D as well, the upper end position of the tracking target group has not changed from that of FIG. 8B. Therefore, even if the upper end positions of subjects other than the subject 802, which exists at the topmost position on the image among the subjects, change, the reference position 851 does not change. Therefore, the headroom of the subject 802 in the captured image 801 and the headroom of the subject 802 in the captured image 881 are the same. Therefore, as shown in FIG. 8D, regarding the subject with the narrowest headroom in the tracking target group, it becomes possible to bring it closer to the headroom specified by the user.

According to such a configuration, it becomes possible to set one upper end position for the tracking target group in the captured image and control the imaging apparatus so that such an upper end position becomes the target position. In particular, for the subject with the narrowest headroom included in the tracking target group, it becomes possible to control the imaging apparatus 100 so as to match the headroom specified by the user. Therefore, it becomes possible to perform control such that the tracking target is tracked and shot while maintaining the upper end position of the tracking target in the captured image during tracking at a predetermined target height. Therefore, as in a case where there are a plurality of tracking targets, even if it is difficult to keep the size of each tracking target constant in order to perform zoom control according to the spread of the tracking targets, it becomes possible to maintain a predetermined headroom by controlling the imaging apparatus 100 with reference to the upper end of the tracking target group.

Note that here, it is assumed that when there is a single tracking target object, control is performed so as to align the center position of the tracking target object with the center target position specified by the user (step S305, step S306), but it is not particularly limited to such processing. For example, even when there is a single tracking target object, control may be performed so as to align an upper end position 706 of the tracking target object with an upper end target position 761 specified by the user. Accordingly, even when there is a single tracking target, it becomes possible to perform automatic tracking that prioritizes maintaining headroom. Note that in this case, the acquisition processing of the center target position by the target setting unit 214 is no longer essential.

In addition, here, the explanation has been given assuming that the same calculation is performed in the control amount calculation of pan, tilt, and zoom regardless of whether there is a single tracking target object or a plurality of tracking target objects, but different processes may be performed for these. For example, the threshold of deviation used in the dead zone processing in step S307 may be made smaller in the case where there are a plurality of tracking target objects than in the case where there is a single tracking target object. Also, for example, the dead zone processing in step S307 may be implemented when there is a single tracking target object, and may not be implemented limited to the tilt direction when there are a plurality of tracking target objects. When dead zone processing is not performed, the tilt operation continues until the deviation between the reference position and the target position is eliminated, and thus the reference position can be more accurately matched with the target position in the vertical direction. Therefore, it becomes possible to match the headroom of the tracking target more accurately.

In addition, in the zoom control speed calculation in step S307, when there are a plurality of tracking targets, the control amount may be calculated by a method that does not depend on the reference size and the target size. For example, zoom control may be performed in accordance with the position of the tracking target object existing at the lowermost side on the image (for example, so that the upper end position and the lower end position of the tracking target group are always identical).

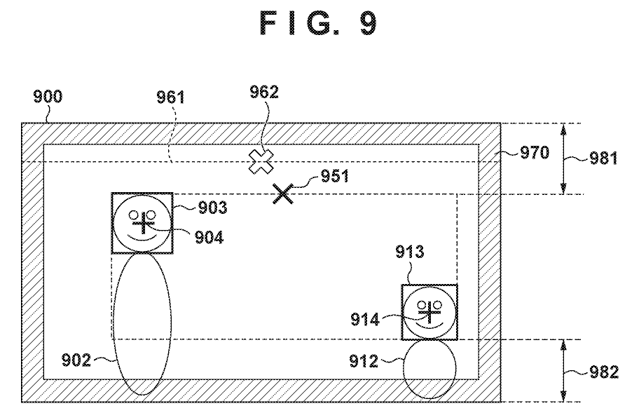

FIG. 9 is a diagram for explaining variations of zoom control. A captured image 900 is shown in FIG. 9. In the captured image 900, a subject 902 and a subject 912 are shown as tracking target objects. In addition, a reference position 951 of the tracking target group, an upper end target position 961, and a group target position 962 are shown in the captured image 900.

For example, the calculation unit 116 may determine the zoom control amount in accordance with the positions of the subjects included in the tracking target group in the captured image. More specifically, the calculation unit 116 determines whether or not any of the subjects included in the tracking target group exists in an outer edge part of the imaging screen of the imaging apparatus 100, and when a subject exists near the outer edge, determines the zoom control amount so as to zoom out such that the subject comes inside the captured image from the outer edge part. As the outer edge part of the shooting screen, an outer edge region 970 (which is a region of a predetermined width from the outer edge of the captured image 900) as exemplified by hatching in FIG. 9 can be set. By performing such control, it becomes possible to perform zoom-out control only when any of the tracking target objects is likely to protrude from the field of view, and thus it becomes possible to obtain a stable shot video while suppressing the frequency of changing the field of view. Here, "any of the tracking targets protrudes from the field of view" indicates that at least a part of the tracking target does not appear on the shooting screen.

In addition, generally, tracking is often performed such that the tracking target is arranged toward the upper side relative to the screen. Therefore, as an example different from the one described above, the calculation unit 116 may determine the zoom control amount so as to zoom out when the distance from the lower end position of the lowermost tracking target (with the highest y-coordinate) on the image to the screen edge becomes shorter than the distance from the upper end position of the uppermost subject (with the lowest y-coordinate) on the image to the screen edge. Arrows 981 shown in FIG. 9 are an example of the distance from the upper end position of the upper end subject to the screen edge, and arrows 982 are an example of the distance from the lower end position of the lower end subject to the screen edge. Here, the calculation unit 116 controls pan and tilt driving so that the reference position 951 of the tracking target group approaches the position of the group target position 962, and determines the zoom control amount so as to zoom out when the length of the arrows 982 becomes shorter than the length of the arrows 981. By performing such control, it becomes possible to reduce the lowermost tracking target on the screen from being too close to the lower end of the screen.

In addition, as an example different from the one described above, zoom may be controlled so as to zoom out when any of the subjects included in the tracking target group satisfies a predetermined composition condition. For example, for the subject 912 in FIG. 9, only a part of the upper body and the head are included in the captured image 900. At this time, as an example, the calculation unit 116 sets a composition condition that all the upper bodies of all tracking targets are shot, and performs zoom control so as to zoom out when the upper body of any subject protrudes from the field of view. By performing such control, it becomes possible to keep the tracking target group within the field of view and also maintain the composition of the tracking targets constituting the tracking target group.

### Embodiment 2

In Embodiment 1, the reference position of the tracking target group was set such that the topmost head top position on the image is the y-coordinate and the horizontal center position of the tracking target group is the x-coordinate. On the other hand, the reference position of the tracking target group according to Embodiment 2 is calculated as the average of the positions of each subject included in the tracking target objects. That is, the subject setting unit 213 according to Embodiment 2 sets the reference position of the tracking target group not as the upper end position of a subject, but as the average of the positions of each subject. By calculating the reference position in this way, the reference position of the tracking target group shifts toward the direction in which the subjects constituting the tracking target group are dense, and thus tracking shooting that brings the position where the tracking targets are dense closer to the composition target becomes possible. Also, regarding headroom, control that brings the average of the headroom of the tracking target group closer to the headroom specified by the user becomes possible.

The configuration and the executed processing in the imaging system 1 according to the present embodiment are basically the same as those in Embodiment 1, and redundant descriptions will be omitted. In the present embodiment, since the content of the processing for calculating the reference position of the tracking target group executed by the calculation unit 116 in step S309 is different from that in Embodiment 1, the difference will be described below.

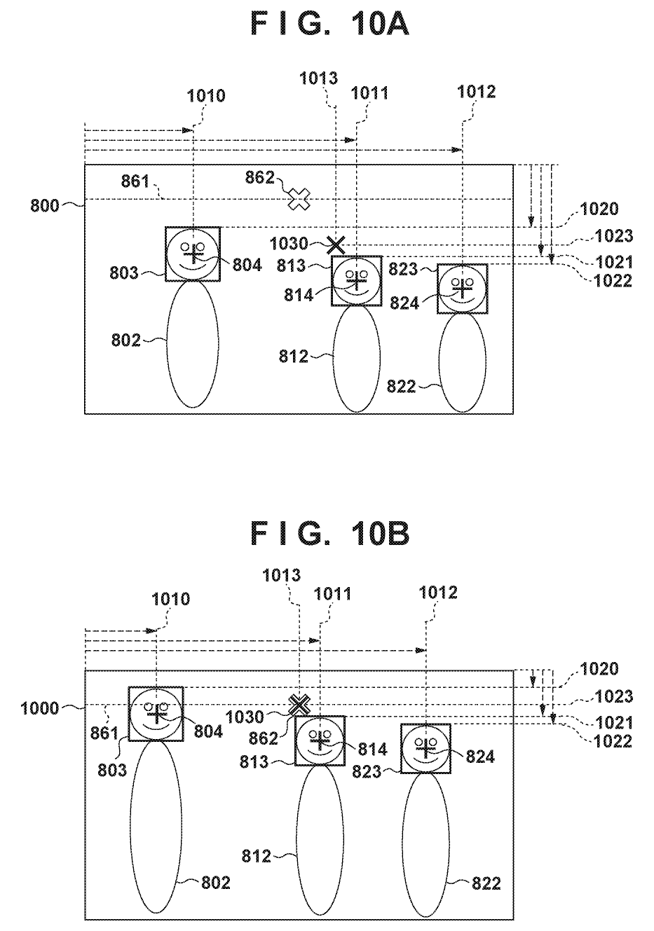

FIGS. 10A and 10B are diagrams for explaining a captured image and the reference position of the tracking target group calculated by the calculation unit 116 of the imaging apparatus 100. FIG. 10A is similar to FIG. 8A in that subjects 802 to 822 are shot in the captured image 800, and identical contents are denoted by the same reference numerals.

The calculation unit 116 according to the present embodiment calculates the reference position of the tracking target group from the captured image 800 shown in FIG. 10A. More specifically, the calculation unit 116 calculates an average position of the subjects included in the tracking target group and sets this as a reference position 1030.

In the present embodiment, the horizontal position of the reference position 1030 is a horizontal position 1013, which is the average position of a horizontal position 1010 of a center position 804, a horizontal position 1011 of a center position 814, and a horizontal position 1012 of a center position 824. In addition, the vertical position of the reference position 1030 is a vertical position 1023, which is the average position of a vertical upper end position 1020 of the rectangle 803, a vertical upper end position 1021 of the rectangle 813, and a vertical upper end position 1022 of the rectangle 823.

Note that if the upper end of the subject region and the upper end of the rectangle do not match, the vertical position 1023 can be acquired using the upper end position of the subject region by correcting the upper end position 1020, the upper end position 1021, and the upper end position 1022 in consideration of the difference in upper end positions, as in Embodiment 1.

The setting of the target position is performed in the same manner as in Embodiment 1. When the imaging apparatus 100 is controlled using such a reference position 1030 and group target position 862 and the deviation between the reference position 1030 and the group target position 862 becomes zero, the captured image 800 becomes like a captured image 1000 shown in FIG. 10B. In this way, according to the configuration according to the present embodiment, tracking shooting that brings the position where the tracking targets are dense closer to the composition target becomes possible. Also, control that brings the average of the headroom of the tracking target group closer to the headroom specified by the user becomes possible.

Note that for the horizontal calculation processing and the vertical calculation processing of the reference position of the tracking target group, those of different embodiments may be arbitrarily combined. For example, the horizontal position of the reference position may be the center position of the rectangular region encompassing the tracking target group as in Embodiment 1, and the vertical position of the reference position may be the average position of the upper end positions of the tracking target group as in Embodiment 2. In this case, control is possible to arrange the region where the tracking target group exists at a position such as one that is horizontally left-right equal relative to the screen, and to bring the average of the headroom of the tracking target group closer to the headroom specified by the user. In addition, the calculation processing of the coordinates in the vertical direction (or the horizontal direction) of the reference position may be executed by selectively using those of each embodiment depending on the situation.

With the configuration and processing described above, in the present embodiment, it becomes possible to perform control that tracks and shoots the tracking target group and brings the average of the headroom of the tracking target group closer to the headroom specified by the user.

### Embodiment 3

In Embodiment 1, the reference position of the tracking target group was set such that the topmost head top position on the image is the y-coordinate. On the other hand, the vertical position (y-coordinate) of the reference position of the tracking target group according to Embodiment 3 is set as a position dividing the space between the upper end position of the subject existing at the topmost position on the image and the upper end position of the subject existing at the lowermost position on the image by a predetermined internal division ratio. By calculating the reference position in this way, adjustment of headroom in accordance with the spread of the tracking target group becomes possible.

The configuration and the executed processing in the imaging system 1 according to the present embodiment are basically the same as those in Embodiment 1, and redundant descriptions will be omitted. In the present embodiment, since the content of the processing for calculating the vertical position of the reference position of the tracking target group executed by the calculation unit 116 in step S309 is different from that in Embodiment 1, the difference will be described below.

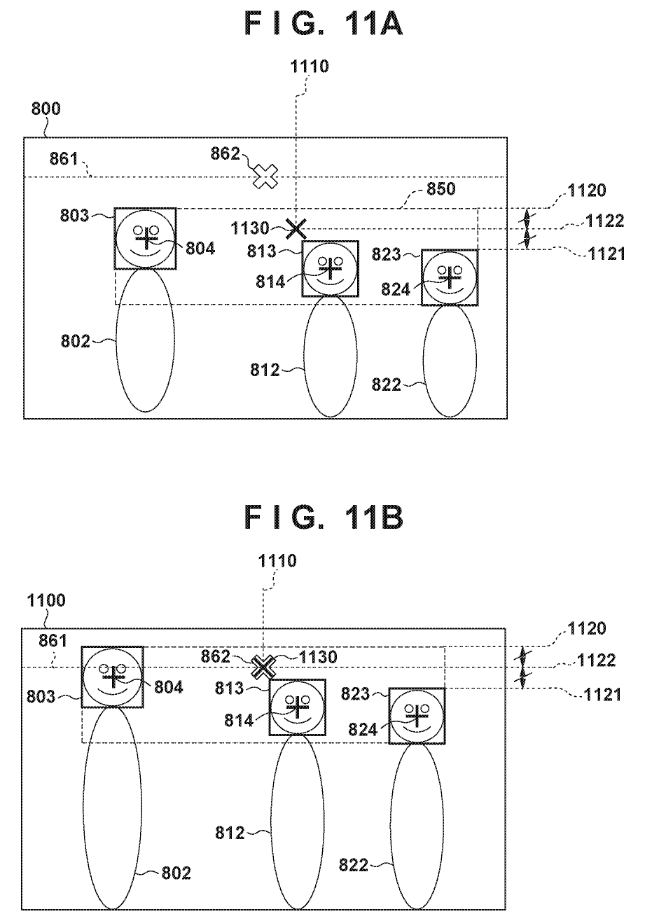

FIGS. 11A and 11B are diagrams for explaining a captured image and the reference position of the tracking target group calculated by the calculation unit 116 of the imaging apparatus 100. FIG. 11A is similar to FIG. 8A in that subjects 802 to 822 are shot in the captured image 800, and identical contents are denoted by the same reference numerals.

The calculation unit 116 calculates the reference position of the tracking target group from the captured image 800 shown in FIG. 11A. Here, for the horizontal position (x-coordinate) of the reference position, the calculation unit 116 sets the horizontal center position of the rectangular region 850 as the horizontal position 1110 of the reference position as in Embodiment 1. In addition, for the vertical position (y-coordinate) of the reference position, the calculation unit 116 sets a vertical position 1122, which is a position dividing the space between an upper end position 1120 of the subject 802 existing at the topmost position on the image and an upper end position 1121 of the subject 822 existing at the lowermost position on the image at a ratio of 1:1. In FIG. 11A, a reference position 1130 is calculated as the reference position of the tracking target group.

Note that if the upper end of the subject region and the upper end of the rectangle do not match, the vertical position 1122 can be acquired using the upper end position of the subject region by correcting the upper end position 1120 and the upper end position 1121 in consideration of the difference in upper end positions, as in Embodiment 1.

The setting of the target position is performed in the same manner as in Embodiment 1. When the imaging apparatus 100 is controlled using such a reference position 1130 and group target position 862 and the deviation between the reference position 1130 and the group target position 862 becomes zero, the captured image 800 becomes like a captured image 1100 shown in FIG. 11B. In this way, according to the configuration according to the present embodiment, regarding the horizontal direction of the screen, the region where the tracking target group exists is arranged at a position such as one that is left-right equal, and regarding the headroom of the tracking target group, control can be performed such that the average value between the subject with the narrowest headroom and the subject with the widest headroom approaches the headroom specified by the user.

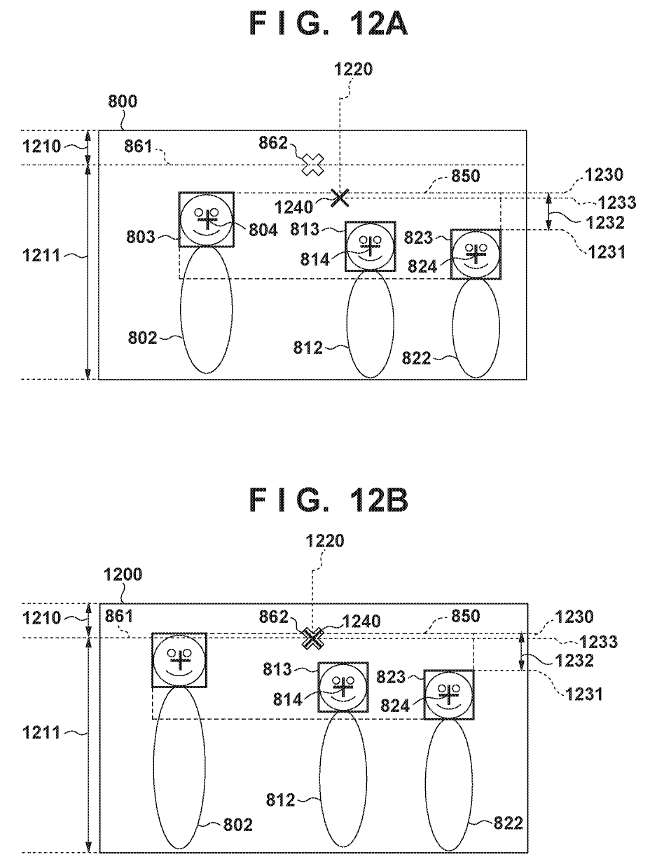

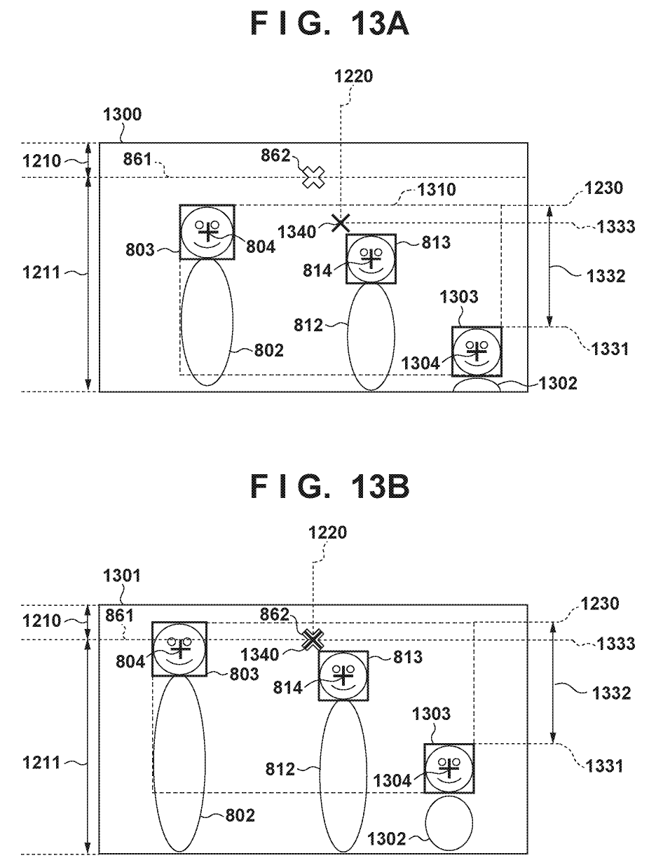

Note that here, the y-coordinate at which the ratio dividing the space between the upper end position 1120 and the upper end position 1121 becomes 1:1 is assumed to be set as the vertical position 1122, but this ratio is not limited to 1:1 and can be set as a desired value. For example, the calculation unit 116 may calculate the vertical position of the reference position using the ratio of the vertical position of the upper end target position 861 to the height of the captured image. An example of the calculation method for the reference position in this case will be described using FIGS. 12A to 12B and 13A to 13B. FIGS. 13A to 13B differ from FIGS. 12A to 12B only in the vertical position of the subject 822, and the tracking target group in FIGS. 13A to 13B exists over a wider vertical range than the tracking target group in FIGS. 12A to 12B.

FIG. 12A is similar to FIG. 8A in that subjects 802 to 822 are shot in the captured image 800, and identical contents are denoted by the same reference numerals. In addition, in a captured image 1300 shown in FIG. 13A, subjects similar to those in the captured image 800 of FIG. 8A are shot except that a subject 1302 is shot instead of the subject 822, and identical contents are denoted by the same reference numerals.

In addition, in FIGS. 12A and 13A, the upper end target position 861 is shown as in FIG. 8A. Here, it is assumed that the position of the upper end target position 861 in FIGS. 12A and 13A is at a position internally dividing the height of the captured image at a ratio of M:N (M and N are positive integers). That is, it is assumed that the ratio of the length of arrows 1210 to the length of arrows 1211 shown in FIGS. 12A and 13A is M:N.

First, the example of FIGS. 12A to 12B will be described. The calculation unit 116 calculates the reference position of the tracking target group from the captured image 800 shown in FIG. 12A. Here, for the horizontal position (x-coordinate) of the reference position, the calculation unit 116 sets the horizontal center position of the rectangular region 850 as a horizontal position 1220 of the reference position as in Embodiment 1. Here, for the vertical position (y-coordinate) of the reference position, the calculation unit 116 sets a vertical position 1233, which is a position dividing arrows 1232 between the upper end position 1230 of the subject 802 existing at the topmost position on the image and the upper end position 1231 of the subject 822 existing at the lowermost position on the image at a ratio of M:N. In FIG. 12A, a reference position 1240 is calculated as the reference position of the tracking target group. In this way, in the example of FIGS. 12A to 12B, with the y-coordinate of the target position being the position internally dividing the height of the captured image into M:N, the y-coordinate of the reference position is set as the position internally dividing the space between the upper end position 1230 of the subject 802 existing at the topmost position on the image and the upper end position 1231 of the subject 822 existing at the lowermost position on the image into the same M:N.

The setting of the target position is performed in the same manner as in Embodiment 1. When the imaging apparatus 100 is controlled using such a reference position 1240 and group target position 862 and the deviation between the reference position 1240 and the group target position 862 becomes zero, the captured image 800 becomes like a captured image 1200 shown in FIG. 12B. According to such a configuration, regarding the headroom of the tracking target group, control can be performed such that the internal division point of the subject with the narrowest headroom and the subject with the widest headroom approaches the headroom specified by the user. In particular, as in FIGS. 12A to 12B, when the target position set by the user is biased toward the upper side of the screen, regarding the subject with the narrowest headroom in the tracking target group, it becomes possible to bring it closer to the headroom specified by the user.

Next, the example of FIGS. 13A to 13B will be described. The calculation unit 116 calculates the reference position of the tracking target group from the captured image 1300 shown in FIG. 13A. Here, for the horizontal position (x-coordinate) of the reference position, the calculation unit 116 sets the horizontal center position of the rectangular region 850 as the horizontal position 1220 of the reference position as in Embodiment 1. Here, for the vertical position (y-coordinate) of the reference position, the calculation unit 116 sets a vertical position 1333, which is a position dividing an arrow 1332 between the upper end position 1230 of the subject 802 existing at the topmost position on the image and the upper end position 1331 of the subject 1302 existing at the lowermost position on the image at a ratio of M:N. In FIG. 13A, a reference position 1340 is calculated as the reference position of the tracking target group.

The setting of the target position is performed in the same manner as in Embodiment 1. When the imaging apparatus 100 is controlled using such a reference position 1340 and group target position 862 and the deviation between the reference position 1340 and the group target position 862 becomes zero, the captured image 800 becomes like a captured image 1301 shown in FIG. 13B. According to such a configuration, regarding the headroom of the tracking target group, control can be performed such that the internal division point of the subject with the narrowest headroom and the subject with the widest headroom approaches the headroom specified by the user. In addition, in particular, when the vertical distribution of the tracking target group is wide as in FIGS. 13A to 13B, it becomes possible to arrange the region where the tracking target group exists toward the center relative to the vertical direction of the screen, regardless of the setting of the target position by the user. As a result, it becomes possible to reduce the amount of zoom-out required to keep the subject group within the field of view.

In addition, the calculation processing of the coordinates in the vertical direction (or horizontal direction) of the reference position may be executed by selectively using those of each embodiment depending on the situation. For example, the vertical position of the reference position may be calculated by the method of Embodiment 1 when the vertical distribution of the tracking target group is narrow, and by the method according to the present embodiment when the distribution is wide.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-047270, filed Mar. 21, 2025, which is hereby incorporated by reference herein in its entirety.

What is claimed is:

1. An information processing apparatus comprising:
one or more memories storing instructions; and
one or more processors executing the instructions to:
set a first reference position for a plurality of subjects in a first captured image captured by an imaging apparatus;
set a first target position for the plurality of subjects in the first captured image; and
control the imaging apparatus so that the first reference position becomes the first target position.

2. The information processing apparatus according to claim 1, wherein the first reference position is an upper end position of a subject existing at a topmost side in the first captured image among the plurality of subjects.

3. The information processing apparatus according to claim 1, wherein the first reference position is an average position of respective upper end positions of the plurality of subjects.

4. The information processing apparatus according to claim 1, wherein the first reference position is a position that internally divides, at a predetermined ratio, a space between an upper end position of a subject existing at a topmost side in the first captured image among the plurality of subjects and an upper end position of a subject located at a lowermost side in the first captured image among the plurality of subjects.

5. The information processing apparatus according to claim 4, wherein the predetermined ratio is a ratio at which a y-coordinate of the first target position internally divides a height of the first captured image.

6. The information processing apparatus according to claim 4, wherein the predetermined ratio is 1:1.

7. The information processing apparatus according to claim 1, wherein a y-coordinate of the first target position is a position that internally divides a height of the first captured image at a predetermined ratio.

8. The information processing apparatus according to claim 1, wherein a y-coordinate of the first target position is set based on a user input.

9. The information processing apparatus according to claim 1, wherein the one or more processors further execute the instructions to set, in a case where only one subject to be tracked exists in a second captured image captured by the imaging apparatus, a second target position and a target size during tracking of the only one subject in the second captured image, and
the first target position is set based on the second target position and the target size.

10. The information processing apparatus according to claim 1, wherein, in a case where a deviation of a y-coordinate between the first reference position and the first target position is a first threshold or more, control of an imaging direction or a zoom magnification of the imaging apparatus is performed so that the first reference position matches the first target position, and
in a case where the deviation of the y-coordinate between the first reference position and the first target position is less than the first threshold, the control of the imaging direction or the zoom magnification of the imaging apparatus is not performed.

11. The information processing apparatus according to claim 1, wherein, in a case where only one subject to be tracked exists in a second captured image captured by the imaging apparatus,
the one or more processors further execute the instructions to:
set a second reference position for the only one subject in the second captured image; and
set a second target position during tracking of the only one subject in the second captured image, wherein
in a case where a deviation of a y-coordinate between the second reference position and the second target position is a second threshold or more, control of an imaging direction or a zoom magnification of the imaging apparatus is performed so that the second reference position matches the second target position,
in a case where the deviation of the y-coordinate between the second reference position and the second target position is less than the second threshold, the control of the imaging direction or the zoom magnification of the imaging apparatus is not performed,
in a case where the deviation of the y-coordinate between the first reference position and the first target position is a third threshold, which is smaller than the second threshold, or more, control of the imaging direction or the zoom magnification of the imaging apparatus is performed so that the first reference position matches the first target position, and
in a case where the deviation of the y-coordinate between the first reference position and the first target position is less than the third threshold, the control of the imaging direction or the zoom magnification of the imaging apparatus is not performed.

12. The information processing apparatus according to claim 1, wherein the one or more processors further execute the instructions to control a zoom magnification of the imaging apparatus so that a ratio occupied by the plurality of subjects in the first captured image is kept constant.

13. The information processing apparatus according to claim 1, wherein the one or more processors further execute the instructions to:
set an outer edge part in the first captured image; and
control a zoom magnification of the imaging apparatus so that, in a case where a subject located at a lowermost side in the first captured image among the plurality of subjects exists in the outer edge part, the subject located at the lowermost side is positioned further inside than the outer edge part in the first captured image.

14. An information processing method comprising:
setting a first reference position for a plurality of subjects in a first captured image captured by an imaging apparatus;
setting a first target position for the plurality of subjects in the first captured image; and
controlling the imaging apparatus so that the first reference position becomes the first target position.

15. A non-transitory computer-readable recording medium storing a program for causing a computer to execute an information processing method, the method comprising:
setting a first reference position for a plurality of subjects in a first captured image captured by an imaging apparatus;
setting a first target position for the plurality of subjects in the first captured image; and
controlling the imaging apparatus so that the first reference position becomes the first target position.
